(19) United States
(12) Patent Application Publication
(10) Pub. No.: US 2025/0264876 A1
(43) Pub. Date: Aug. 21, 2025

(54) COMMUNICATING BETWEEN A CONTROL COMPUTER AND A GROUND ROBOT

(71) Applicant: Textron Systems Corporation, Hunt Valley, MD (US)

(72) Inventors: Lowry Michael Davidson,, JR., Reisterstown, MD (US); Aaron Russell Grieb, Spring Grove, PA (US)

(21) Appl. No.: 19/059,605

(22) Filed: Feb. 21, 2025

Related U.S. Application Data
(60) Provisional application No. 63/556,118, filed on Feb. 21, 2024.

(51) Int. Cl. G05D 1/226; G05D 1/86; G05D 109/10; G05D 111/30

(52) U.S. Cl. CPC G05D 1/226; G05D 1/86; G05D 2109/10; G05D 2111/30

(57) ABSTRACT

A technique of controlling a ground robot includes simultaneously operating both a first drive-control method and a second drive-control method in the ground robot. The first drive-control method actively controls the ground robot, the second drive-control method does not actively control the ground robot. At least one of the first drive-control method and the second drive-control method is configured to apply respective torques to left and right tracks of the ground robot. The technique further includes establishing communications between the ground robot and a control computer based on the ground robot emitting a discovery signal. In response to the ground robot receiving one or more messages from the control computer, the technique further includes actively controlling the ground robot using the second drive-control method in place of the first drive-control method.

### CROSS-REFERENCE TO RELATED APPLICATIONS

This application claims the benefit of U.S. Provisional Patent Application No. 63/556,118, filed Feb. 21, 2024, the contents and teachings of which are incorporated herein by reference in their entirety.

### BACKGROUND

Tracked robotic vehicles, also referred to as “ground robots,” typically run by remote control. For example, a remote user may operate a control computer, which wirelessly sends commands to a ground robot for advancing, reversing, turning, stopping, and the like. The ground robot typically includes a transceiver for receiving commands from the computer and for transmitting data back to the computer for presentation to the user.

Communications between control computers and ground robots are typically managed by an interface that exposes an API (application programmer interface) that allows users to control the ground robot. The interface defines a particular format for messages and supports a communication protocol, such as CAN (controller area network) protocol.

### SUMMARY

Certain embodiments are directed to a method of controlling a ground robot. The method includes simultaneously operating both a first drive-control method and a second drive-control method in the ground robot. The first drive-control method actively controls the ground robot, and the second drive-control method not actively control the ground robot. At least one of the first drive-control method and the second drive-control method is configured to apply respective torques to left and right tracks of the ground robot. The method further includes establishing communications between the ground robot and a control computer based on the ground robot emitting a discovery signal and, in response to the ground robot receiving one or more messages from the control computer, actively controlling the ground robot using the second drive-control method in place of the first drive-control method.

According to one or more further embodiments, the first drive-control method is one of a differential torque drive-control method and a speed and steering drive-control method, and the second drive-control method is one of a heading drive-control method and a waypoints drive-control method.

According to one or more further embodiments, establishing communications between the ground robot and the control computer is performed using one of (i) CAN (controller area network) and (ii) UDP (user datagram protocol) over IP (Internet protocol).

According to one or more further embodiments, emitting the discovery signal includes wirelessly sending a mobility message periodically, the mobility message indicating a currently active drive-control method in the ground robot.

According to one or more further embodiments, the method further includes updating a controller identifier of the ground robot to identify the control computer from among multiple control computers as a sole active controller of the ground robot.

According to one or more further embodiments, while the control computer is actively controlling the ground robot, the method further includes transmitting telemetry data about the ground robot to a second control computer to enable the second control computer to display the telemetry data of the ground robot.

According to one or more further embodiments, the telemetry data includes at least one of fault information, battery status, and engine status of the ground robot.

According to one or more further embodiments, transmitting the telemetry data includes sending a diagnostic trouble code along with an accompanying human-readable text description of the diagnostic trouble code.

According to one or more further embodiments, the method further includes, while the control computer is actively controlling the ground robot, receiving a request from a second control computer for actively controlling the ground robot, and granting control of the ground robot to the second control computer responsive to the second control computer having higher priority than the control computer.

According to one or more further embodiments, the method further includes, while the control computer is actively controlling the ground robot, receiving a request from a second control computer for actively controlling the ground robot, and refusing the request from the second control computer responsive to the second control computer having lower priority than the control computer.

According to one or more further embodiments, the method further includes receiving a release-control request from the control computer for releasing active control over the ground robot, after receiving the release-control request, receiving a second request from the second control computer for actively controlling the ground robot, and granting the second request such that the second control computer actively controls the ground robot.

Other embodiments are directed to a ground robot that includes left and right tracks, a wireless interface, and control circuitry constructed and arranged to simultaneously operate both a first drive-control method and a second drive-control method in the ground robot, such that the first drive-control method actively controls the ground robot and the second drive-control method does not actively control the ground robot. At least one of the first drive-control method and the second drive-control method is configured to apply respective torques to the left and right tracks of the ground robot. The control circuitry is further constructed and arranged to establish communications between the ground robot and a control computer based on the ground robot emitting a discovery signal via the wireless interface and, in response to receipt by the ground robot of one or more messages from the control computer via the wireless interface, to actively control the ground robot using the second drive-control method in place of the first drive-control method.

According to one or more further embodiments, the ground robot further includes a first electric motor arranged to drive the left track and a second electric motor arranged to drive the right track. The control circuitry is further constructed and arranged to control the first electric motor and the second electric motor to apply respective first and second torques to the left and right tracks when each of the first drive-control method and the second drive-control method is active.

According to one or more further embodiments, the control circuitry constructed and arranged to emit the discovery signal is further constructed and arranged to wirelessly send a mobility message periodically. The mobility message indicates a currently active drive-control method in the ground robot.

According to one or more further embodiments, the control circuitry is further constructed and arranged to update a controller identifier of the ground robot to identify the control computer from among multiple control computers as a sole active controller of the ground robot.

According to one or more further embodiments, while the control computer is actively controlling the ground robot, the control circuitry is further constructed and arranged to transmit telemetry data about the ground robot to a second control computer to enable the second control computer to display the telemetry data of the ground robot.

According to one or more further embodiments, the telemetry data includes at least one of fault information, battery status, and engine status of the ground robot.

According to one or more further embodiments, transmitting the telemetry data includes sending a diagnostic trouble code along with an accompanying human-readable text description of the diagnostic trouble code.

According to one or more further embodiments, while the control computer is actively controlling the ground robot, the control circuitry is further constructed and arranged to receive a request from a second control computer for actively controlling the ground robot, and to grant control of the ground robot to the second control computer responsive to the second control computer having higher priority than the control computer.

According to one or more further embodiments, while the control computer is actively controlling the ground robot, the control circuitry is further constructed and arranged to receive a request from a second control computer for actively controlling the ground robot, and to refuse the request from the second control computer responsive to the second control computer having lower priority than the control computer.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced according to one or more embodiments.

FIG. 2 is a block diagram of an example control computer shown in FIG. 1 according to one or more embodiments.

FIG. 3 is a block diagram of an example electronic system in an example tracked robotic vehicle shown in FIG. 1 according to one or more embodiments.

FIG. 4 is an example screenshot displayed by a GUI of the control computer in response to a torque control method or an aided torque control method being selected, according to one or more embodiments.

FIG. 5 is an example screenshot displayed by the GUI of the control computer in response to a speed control method being selected. According to one or more embodiments.

FIG. 6 is an example screenshot displayed by the GUI of the control computer in response to a heading control method being selected, according to one or more embodiments.

FIG. 7 is an example screenshot displayed by the GUI of the control computer in response to a waypoints control method being selected, according to one or more embodiments.

FIG. 8 is an example screenshot displayed by the GUI of the control computer in response to a configuration control being activated, according to one or more embodiments.

FIG. 9 is a flowchart showing an example method of controlling the tracked robotic vehicle of FIG. 1 using a control computer, according to one or more embodiments.

FIG. 10 is a flowchart showing an example method of associating a tracked vehicle with a control computer, according to one or more embodiments.

FIG. 11 is a flowchart showing an example method of switching a source of control of a tracked vehicle from a first control computer to a second control computer, according to one or more embodiments.

FIG. 12 is a flowchart showing an example method of preventing a second control computer from controlling a tracked vehicle and later allowing the second control computer to control the tracked vehicle, according to one or more embodiments.

FIG. 13 is a flowchart showing an example method of providing telemetry data to a second control computer while a tracked vehicle is controlled by a first control computer. According to one or more embodiments.

FIG. 14 is a flowchart showing an example method of controlling a ground robot, according to one or more embodiments.

### DETAILED DESCRIPTION

Embodiments of the improved technique will now be described. One should appreciate that such embodiments are provided by way of example to illustrate certain features and principles but are not intended to be limiting.

Prior interfaces between control computers and ground robots are limited in their capabilities. For example, prior interfaces may support a single drive-control method for driving the robot, such as torque control, whereas ground robots may inherently support multiple drive-control methods, besides just torque control. In addition, prior interfaces may be optimized for Ackermann steering designed for turning front wheels of a vehicle, whereas ground robots typically have tracks rather than steerable wheels and steer by running different tracks at different speeds. What is needed, therefore, is a robotic platform interface that is better suited for controlling tracked vehicles and is more capable of fully utilizing a ground robot's features and design.

The above need is addressed at least in part by an improved technique that provides an interface between control computers (also called “control stations”) and ground robots. The interface supports multiple drive-control methods and steering of the ground robot using differential track control. Advantageously, the improved technique leverages the capabilities of ground robots and is better suited for their control.

### Section I: Drive-Control Switching:

Section I describes an example technique for switching drive-control methods in a tracked robotic vehicle, such as a ground robot, according to one or more embodiments. The technique includes simultaneously operating multiple drive-control methods within the vehicle based on established settings but selecting only a single drive-control method for actively controlling the vehicle at a time. With the vehicle using a first drive-control method, the vehicle receives a command for assuming a second control-control method and responds by selecting the second drive-control method in place of the first control method for controlling the vehicle. Because the second drive-control method is already operational with established settings when the command is received, the vehicle can transition instantly from the first drive-control method to the second drive-control method without having to stop the vehicle.

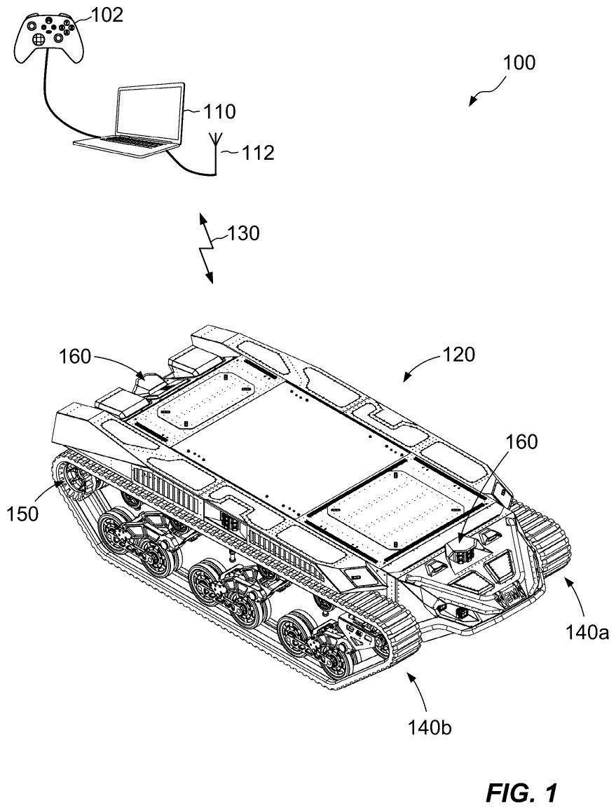

FIG. 1 shows an example environment 100 in which embodiments of the improved technique can be practiced. Here, a handheld controller 102 is operatively coupled to a control computer 110 for controlling a robotic tracked vehicle 120, i.e., a ground robot. A connection between the controller 102 and the computer 110 may be made using a cable (as shown) or wirelessly, such as using Bluetooth or some other wireless protocol. The hand-held controller 102 may be a standard, commercially available game controller (e.g., an Xbox Controller) or it may be a custom controller, the particulars of which are not critical. In some embodiments, the controller 102 may be replaced with a conventional keyboard, mouse, or other input device. The control computer 110 may be any type of computer capable of running software, providing a GUI to support interaction with the user, and capable of connecting to an antenna 112 for supporting wireless communication, such as Wi-Fi, Bluetooth, Satellite, or the like. Examples of the control computer 110 include a laptop computer, desktop computer, tablet computer, game controller, or the like. The antenna 112 may be separate from the computer 110 (as shown), or it may be built into the computer.

A human user (not shown), or some other user, such as a robot, program, machine, or the like, may operate the controller 102 for controlling the ground robot 120 using wireless signals 130. The ground robot may be located an arbitrary distance away from the control computer 110. The ground robot 120 is constructed and arranged to receive commands and other messages from the control computer 110 and to respond to those commands and other messages by assuming various drive-control methods and by driving in accordance with those drive-control methods.

In an example, the ground robot 120 includes left and right tracks 140a and 140b, which may be driven forward and back by respective motors (not shown) via respective drive sprockets 150. Each drive sprocket 150 has teeth that engage a respective track (left or right). The ground robot 120 further includes various cameras 160 for capturing live video of the ground robot's surroundings. The ground robot 120 may transmit the live video back to the control computer 110, or to some other computer co-located with the control computer 110, for presenting the live video to the user, who may employ the live video for guiding the ground robot through the surrounding terrain using the controller 102 and the GUI displayed by the control computer 110.

In accordance with one or more embodiments, the ground robot 120 is constructed and arranged to switch seamlessly and rapidly among multiple control methods, such as torque, aided torque, speed-and-steering, heading, and waypoint control methods. This ability enables the ground robot 120 to adapt quickly to different circumstances and terrains without having to stop the ground robot 120 and without the user having to orchestrate complex procedures.

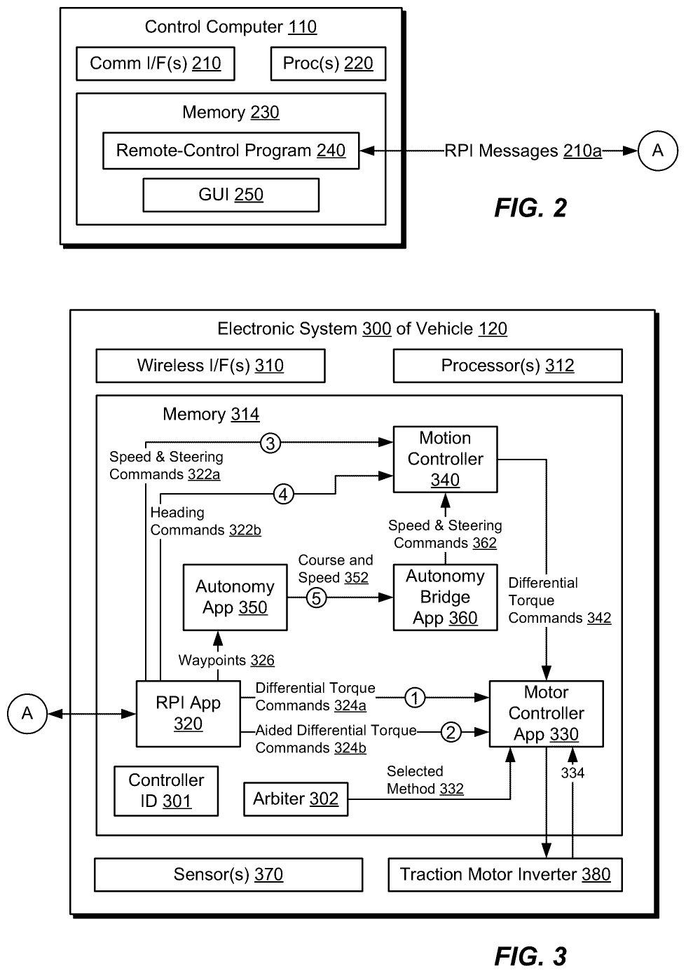

FIG. 2 shows an example control computer 110 in additional detail. As shown, the control computer 110 includes one or more communication interfaces 210, a set of processors 220, and memory 230. The communication interface(s) 210 include, for example, a wireless communication interface for sending and receiving messages via the antenna 112 (FIG. 1). The processor(s) 220 include one or more processing chips and/or assemblies, such as any number of multi-core CPUs (central processing units). The memory 230 includes both volatile memory, e.g., RAM (Random Access Memory), and non-volatile memory, such as one or more ROMs (Read-Only Memories), disk drives, solid state drives, and the like. The processor(s) 220 and the memory 230 together form control circuitry, which is constructed and arranged to carry out various methods and functions as described herein. Also, the memory 230 includes a variety of software constructs realized in the form of executable instructions. When the executable instructions are run by the processor(s) 220, the processor(s) 220 are made to carry out the operations of the software constructs. Although certain software constructs are specifically shown and described, it is understood that the memory 230 typically includes many other software components, which are not shown, such as an operating system, various applications, processes, and daemons.

As further shown in FIG. 2, the memory 230 “includes,” i.e., realizes by execution of software instructions, a remote-control program 240 and a GUI 250. The remote-control program 240 is a software construct constructed and arranged to receive user input from the GUI 250 and to respond to the user input by sending robotic platform interface (RPI) messages 210a to the ground robot 120. Such RPI messages 210a can prescribe a wide range of ground robot functions, which include drive-control method commands and other messages for establishing desired drive control methods and their associated settings. RPI messages 210a may also be received from the ground robot 120, for providing telemetry data produced by the ground robot 120. Such telemetry data may be displayed by the control computer 110 via the GUI 250. In some examples, the GUI 250 is integral with the remote-control program 240 rather than being a distinct software component.

FIG. 3 shows portions of an example electronic system 300 of the ground robot 120. The electronic system 300 includes one or more wireless communication interfaces 310, a set of processors 312, and memory 314, which may be provided in similar forms and with similar capabilities as the corresponding features 210, 220, and 230 described in connection with FIG. 2. The electronic system 300 may further include various sensors 370, such as an IMU, a GPS receiver, an INS system, a speedometer, and the like, as well as a traction motor inverter 380. The traction motor inverter 380 is constructed and arranged to drive motors (not shown) of the ground robot 120, such as left and right motors for driving the left and right tracks 140a and 140b of the ground robot (FIG. 1). In some examples, the traction motor inverter 380 is constructed and arranged to generate one or more feedback signals, such as torque levels produced by the motors, which may be based on current drawn by the motors during operation (assuming electric motors are used). Although not shown, each motor may be coupled to a respective drive sprocket 150 of the ground robot 120 via a respective drive shaft and gearbox.

As further shown in FIG. 3, the memory 314 includes an arbiter 302, a robotic platform interface (RPI) application 320, a motor controller application 330, a motion controller 340, an autonomy application 350, and an autonomy bridge application 360. The memory may also store a controller identifier 301, which uniquely identifies the control computer 110 from among multiple control computers capable of controlling the ground robot 120. The arbiter 302 is constructed and arranged to indicate which of multiple drive control methods is currently active. The RPI application 320 is constructed and arranged to communicate with the control computer using RPI messages 210a. In an example, RPI messages 210a are sent and received in accordance with a messaging protocol that is optimized for remote control. Any protocol may be used, however. Examples of RPI messages 210a include commands for establishing drive control methods and associated settings, as well as commands for directly driving the ground robot 120.

The motor controller application 330 is constructed and arranged to receive inputs specifying desired torque levels and to provide output signals for driving the traction motor inverter 380 for powering the left and right motors in such a way as to generate the prescribed torque levels. A torque feedback signal 334 may be provided for each motor for supporting closed-loop control over motor torque. The motor controller application 330 is further constructed and arranged to receive a selected method 332, which may be produced by the arbiter 302. The selected method 332 identifies a currently selected drive control method, e.g., one of torque, aided torque, speed, heading, and waypoint control methods. The motor controller application 330 is further constructed and arranged to respond to the selected method 332 by enabling control using the selected method 332 and disabling control using the other methods. One should appreciate that the functions ascribed to the arbiter 302 may instead be performed by other constructs, such as the RPI application 320.

The software constructs shown within memory 314 support multiple drive-control paths, one for each drive-control method. The different drive-control paths are labeled with encircled numerals 1-5, where path (1) indicates torque control, path (2) indicates aided torque control, path (3) indicates speed control, path (4) indicates heading control, and path (5) indicates waypoint control.

For torque control, the drive-control path (1) is formed between the RPI application 320 and the motor controller application 330. Differential torque commands 324a may specify left and right torque values in relative terms, e.g., from −100% to +100%, where −100% represents the maximum reverse-driving torque available from each motor and +100% represents the maximum forward-driving torque. With the torque control method, for example, the motor controller application 330 drives the traction motor inverter 380 so as to achieve the left and right torque levels prescribed by the differential torque commands 324a.

Aided torque control is similar to torque control and follows a parallel (or identical) path (2), but in this case aided differential torque commands 324b (e.g., also expressed as percentages) provide smoothed or otherwise processed torque values, which are intended to make it easier for human operators to control the ground robot 120. For example, raw torque values may be based on joystick position of the handheld controller 102, which may be sensitive to small deflections. Aided torque may provide moving averages of torque values to prevent sudden, inadvertent changes. It may also remap controller input, such as by requiring greater stick deflections for incremental changes near 0% torque than are required for incremental changes near +/−100% torque, e.g., by remapping stick input to a logarithmic scale. The processing of raw stick input to processed torque values may be performed by any suitable component, such as within the RPI application 320, within the control computer 110, or elsewhere.

For speed control, the drive-control path (3) is formed from the RPI application 320, to the motion controller 340, and then to the motor controller application 330. The RPI application 330 translates RPI messages 210a from the control computer 110 to speed and steering commands 322a. The speed and steering commands 322a may include speed settings, yaw-rate settings, and direct steering input, e.g., from a control stick. In an example, the motion controller 340 operates under closed-loop control, receiving feedback from the sensors 370 and/or the traction motor inverter 380 and transforming the speed and steering commands 322a into differential (left and right) torque commands 342. These torque commands 342 are fed to the motor controller application 330, which drives the traction motor inverter 380 as described above to power the left and right motors. The feedback is closed when the speed of the left and right motors matches the speed prescribed by the speed and steering commands 322a.

The term “application” as used in describing certain features of FIG. 3 refers to a software component constructed and arranged to perform certain indicated functions, such as real-time control functions. An application may be realized as a stand-alone application, a plug-in or add-in, a subroutine or function, a software object, or any other software construct that includes instructions.

For heading control, the drive-control path (4) starts at the RPI application 320, proceeds to the motion controller 340, and then proceeds to the motor controller application 330. In an example, this path (4) is parallel to (or identical to) the speed-control path (3). Here, however, the RPI application 320 translates input from the control computer 110 to heading commands 322b, which the motion controller 340 transforms into differential torque commands 342. The heading commands 322b specify particular turning maneuvers, which may be performed while the ground robot 120 is stopped or when it is in motion. In an example, turning of the ground robot 120 is achieved by establishing differential track speeds. For example, the sensors 370, such as the IMU, monitor yaw of the ground robot and enable a turn may be completed under closed-loop control. Speed may also be maintained under closed-loop control based on feedback from sensors 370 and/or from the traction motor inverter 380.

For waypoints control, the drive-control path (5) starts with the RPI application 320 and proceeds to the autonomy application 350, then to the autonomy bridge application 360, then to the motion controller 340, and then to the motor controller application 330. In some examples, the autonomy application 350 and the autonomy bridge application 360 are provided as a single software construct. According to this control method, the RPI application 320 translates one or more RPI messages 210a from the control computer 110 into a set of waypoints 326, e.g., latitude and longitude coordinates, to be visited in a defined sequence. The autonomy application 350 transforms the sequence of waypoints 326 into a corresponding sequence of course (direction) and speed settings 352, which vary as the ground robot 120 progresses from one waypoint to another. In some examples, the autonomy application 350 may be a “smart” application that avoids obstacles, follows roads when available, and applies other features to promote safe travel. The autonomy bridge application 360 transforms the course and speed settings 352 to corresponding speed and steering commands 362, which the motion controller 340 transforms to differential torque commands 342 in the manner described above.

In an example, the above-described drive-control paths (1) through (5), or some subset of these paths, are kept in a continuously active state, such that they have the settings needed for their operation and are primed such that they can immediately take control of the ground robot once they are selected. For example, assume that the ground robot 120 is operating using the speed control method, as indicated by path (3). During this time, the drive-control path (5) for the waypoint control method remains active, continually generating course and speed 352 for traveling to the next waypoint. Likewise, the autonomy bridge application 360 may continuously produce speed and steering commands 362. When a new RPI message 210a arrives specifying a change to the waypoint control method, the electronic system 300 responds by changing the selected method 332 to waypoints, at which point the motor controller application 330 proceeds to control the ground robot 120 using drive-control path (5).

As another example, assume that the ground robot 120 is operating using the aided torque control method, as indicated by path (2). During this time, the ground robot continues to provide speed and steering commands 322a to the motion controller 340, which in turn continues to generate differential torque commands 342, even though the speed control method is not currently selected. When a new RPI message 210a arrives specifying a transition to the speed control method, the motor controller application 330 responds by switching control to path (3), controlling the ground robot using the now selected speed control method. In this manner, transitions between different drive control methods are fast and efficient.

One may observe that continuing to operate drive-control paths that are not currently selected may cause certain paths that normally operate closed-loop to operate open-loop instead. For example, when either of the torque control settings is selected, the motion controller 340 operates open loop, as it has no control over the motors. In such cases, the motion controller 340 may limit its output to values close to expected values when the motion controller 340 does control the motors, such that a transition from either torque method to the speed, heading, or waypoints method can be achieved smoothly and without sudden jumps. In an example, the arbiter 302 determines which drive-control path is currently selected and provides this information (e.g., indicator 332) to all of the drive-control paths, where they are made “aware” of whether they are currently selected. Drive-control paths that are not currently selected can then limit their output excursions in response to large errors. Although the switching of drive-control methods as described herein may be performed directly and without first stopping the ground robot 120, nothing precludes the user from stopping the ground robot 120 when changing drive-control methods. Stopping the ground robot 120 is thus at the user's discretion.

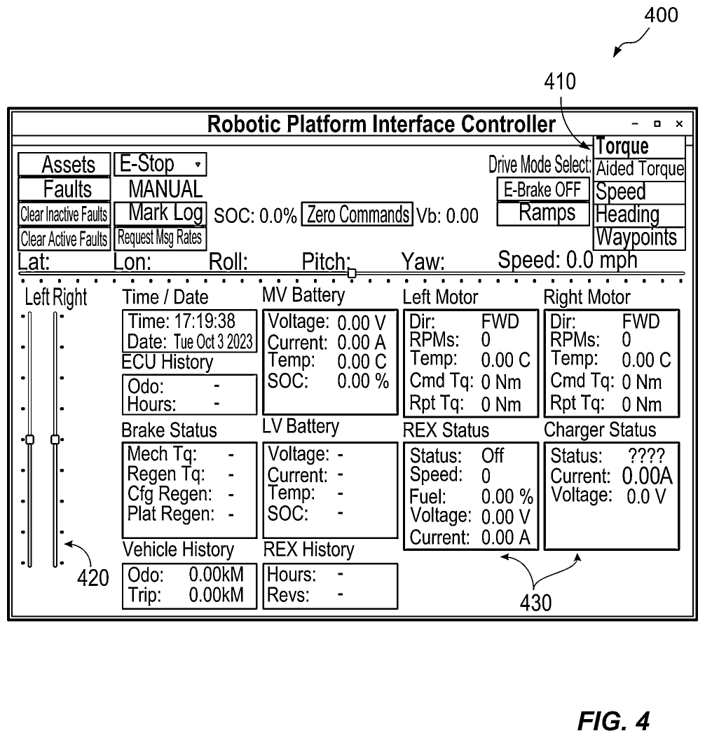

Having described the control operation of the ground robot 120, operation of the control computer 110 that facilitates such ground robot operation will now be described in connection with FIGS. 4 through 8. One should appreciate that the depicted screenshots of FIGS. 4 through 8 are intended merely for illustration and are not intended to be limiting. In an example, the screenshots are rendered by the GUI 250, which may be viewed on a display of the control computer 110, and which may be operated using the handheld controller 102 and/or other input devices, such as a keyboard and/or mouse. Logic behind the GUI 250 and activities prescribed by the GUI may be provided by the remote-control program 240.

FIG. 4 shows an example screenshot 400 of the GUI 250. Here, the user has selected the differential torque control method (“Torque”) from a drop-down list 410, which also allows for selection of the other drive control methods (aided torque, speed, heading, and waypoints). Selecting “Torque” from the drop-down list 410 causes the remote-control program 240 to send one or more RPI messages 210a to the ground robot 120, which receives the message(s) 210a and proceeds to switch to the drive-control path (1). Settings for left and right torque may have initial default values, which may reflect previous settings or may start from zero. A method-specific region 420 of the GUI 250 provides a visual representation of commanded torque to left and right motors. A status region 430 of the GUI provides status information, which may include ground robot telemetry, i.e., parameters monitored by the ground robot 120 and sent back to the control computer 110 via RPI messages 210a.

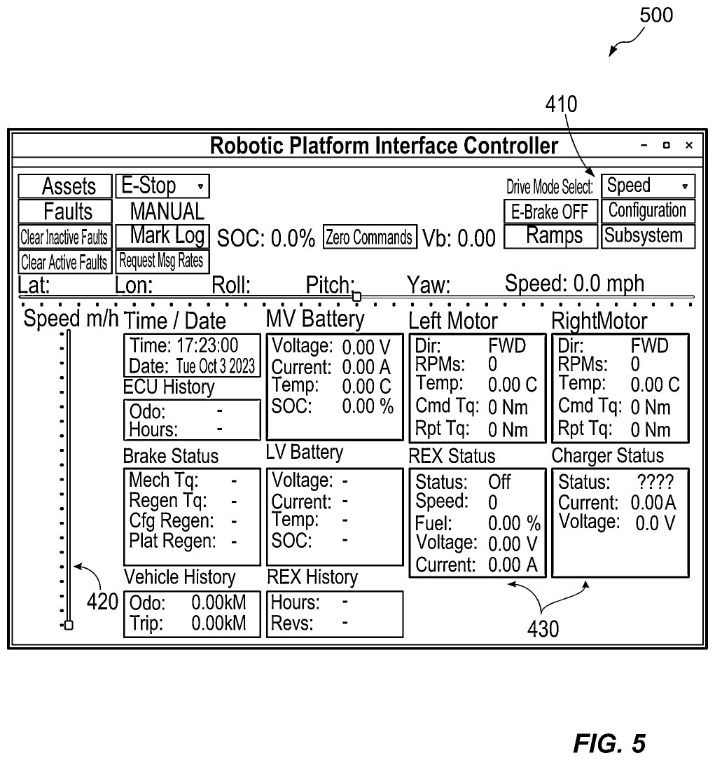

FIG. 5 shows an example screenshot 500 of the GUI 250, following a user selection of the speed control method from the drop-down list 410. Here, the method-specific region 420 has been changed to provide a visual representation of commanded speed. Although not shown in FIG. 5, the GUI may provide a button or other control to command a maximum speed. Speed can be trimmed up and down with a directional pad, and steering can be achieved using a joystick.

The speed method uses absolute values, rather than percentages, receiving user input of maximum speed in units of miles per hour or kilometers per hour, for example. The speed method may employ input from GPS and INS of the ground robot in regulating the ground robot speed. Alternatively or additionally, the speed method may employ an onboard ground robot speedometer. To slow down, the ground robot 120 may first use regeneration and later add service braking (wet brakes) to reach a specified speed.

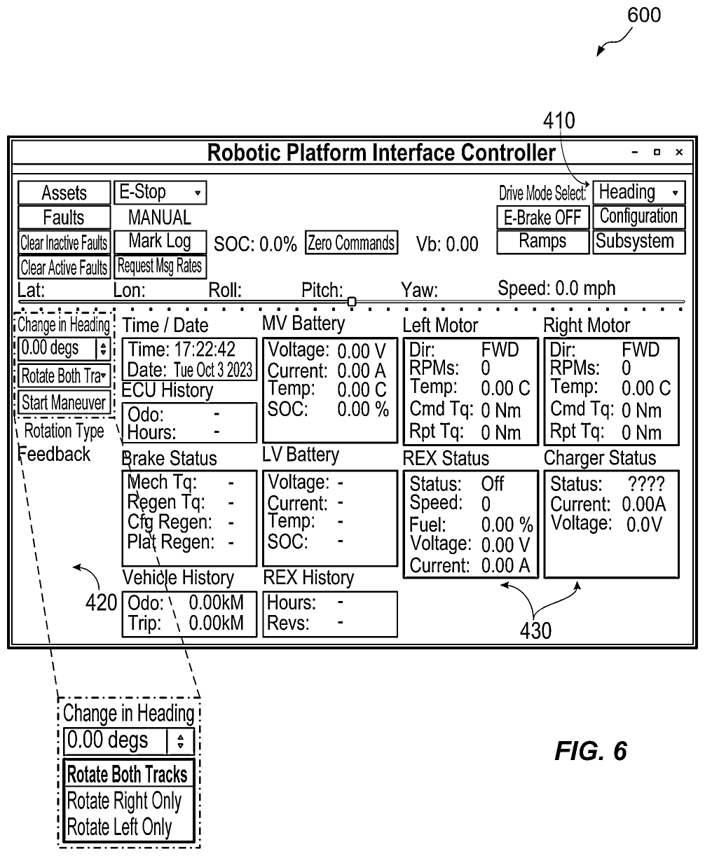

FIG. 6 shows an example screenshot 600 of the GUI 250, following a user selection of the heading control method from the drop-down list 410. Here, the method-specific region 420 has been changed to include a “Change in Heading” region, which allows the user to select a heading change (in degrees) and a rotation type. As shown in the enlarged view below, available rotation types include rotating both tracks, rotating the right track only, and rotating the left track only. The user can enter the desired heading change and rotation type and then click a “Start Maneuver” button or other control to initiate the heading change. Once pressed, the “Start Maneuver” button may change to a “Stop Maneuver” button, which the user may press to stop or interrupt the specified maneuver.

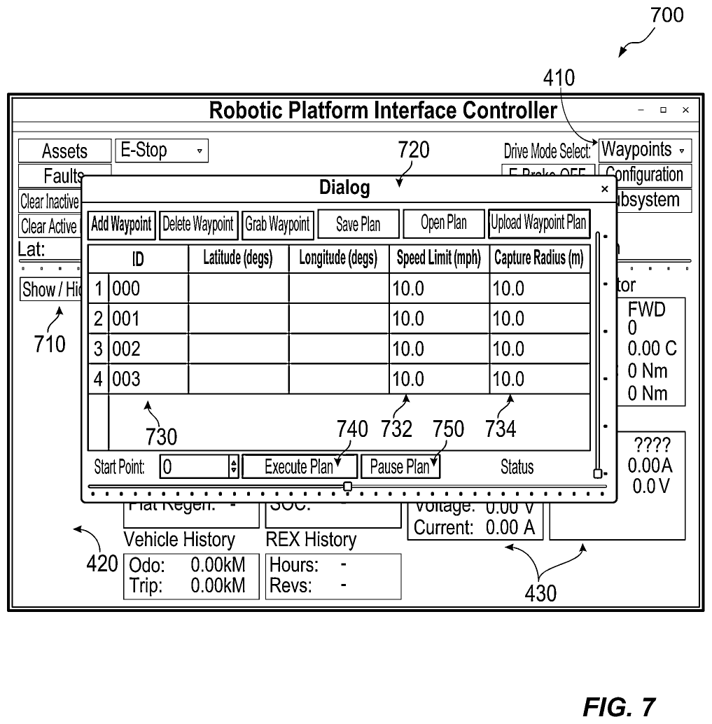

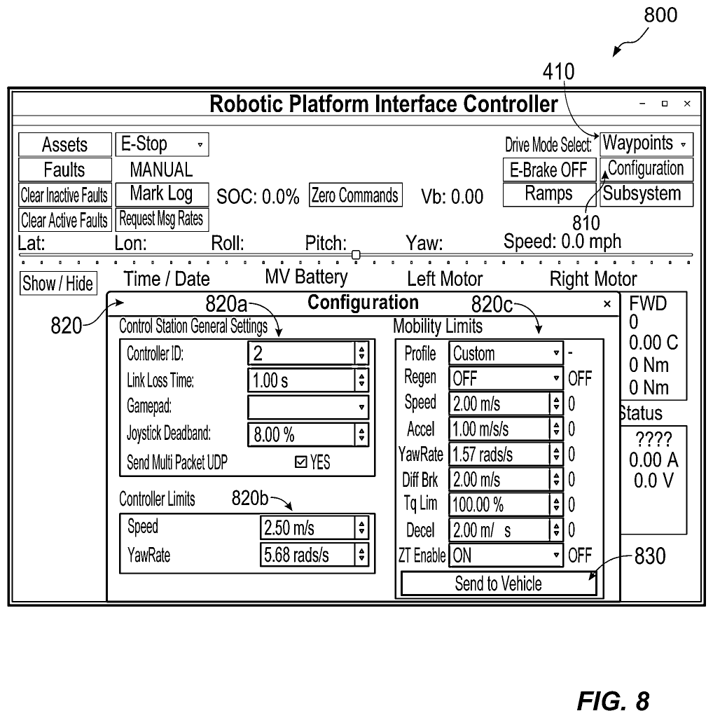

FIG. 7 shows an example screenshot 700 of the GUI 250, following a user selection of the waypoints control method from the drop-down list 410. Here, the method-specific region 420 has been changed to include a control 710, such as a button, for showing or hiding a waypoints dialog box 720, which is shown in the foreground of the figure. The dialog box 720 enables the user to enter any number of waypoints 730 by specifying their latitude and longitude. The user may also specify a speed limit 732 associated with travel to each waypoint and a capture radius 734, i.e., a distance away from the waypoint which, if reached by the ground robot, qualifies as having visited the waypoint. The user may click a button 740 to “Execute Plan,” which sends the list of waypoints to the ground robot 120 and initiates travel. The user may also click a button 750 to “Pause Plan,” which has the effect of pausing execution of the plan.

When the ground robot is controlled using the waypoints method or the heading method, any joystick input (or other directional input) from the handheld controller 102 may be interpreted as an instruction to stop asserting the waypoints or heading method and instead to begin asserting the speed control method. In an example, the GUI responds to any joystick input by changing the indicated control method to the speed method and switching the display to resemble what is shown in FIG. 5. The joystick input also causes the remote-control program 240 to send an RPI message 210a to the ground robot 120 to set the control method to the speed control method.

FIG. 8 shows an example screenshot 800 of the GUI 250, following a user activation of a configuration control 810, which may be provided as a button, for example. In response to the activation, the GUI 250 displays a configuration dialog box 820. As shown, the configuration dialog box 820 includes control station general settings 820a, which apply to the control computer 110 and handheld controller 102, controller limits 820b, which apply to control inputs, and mobility limits 820c, which apply to the ground robot 120. For example, control station general settings 820a include a setting for joystick deadband, which specifies a minimum joystick deflection required before the joystick input is interpreted as a control change. The controller limits 820b include speed and yaw rate, which limit maximum values that may be set by the controller. Mobility limits 820c are enforced by the ground robot 120 itself. The user may establish settings for regenerative braking, speed, acceleration, yaw rate, differential braking, torque limit, deceleration, and zero-turning, for example, and the control computer 110 may send established settings to the ground robot 120, e.g., in response to the user pressing a button 830. In the event that a controller limit 820b set by the user exceeds a mobility limit 820c for some parameter (e.g., yaw rate), the mobility setting 820c takes precedence. This arrangement ensures that the ground robot 120 is always in control of its own maximum settings.

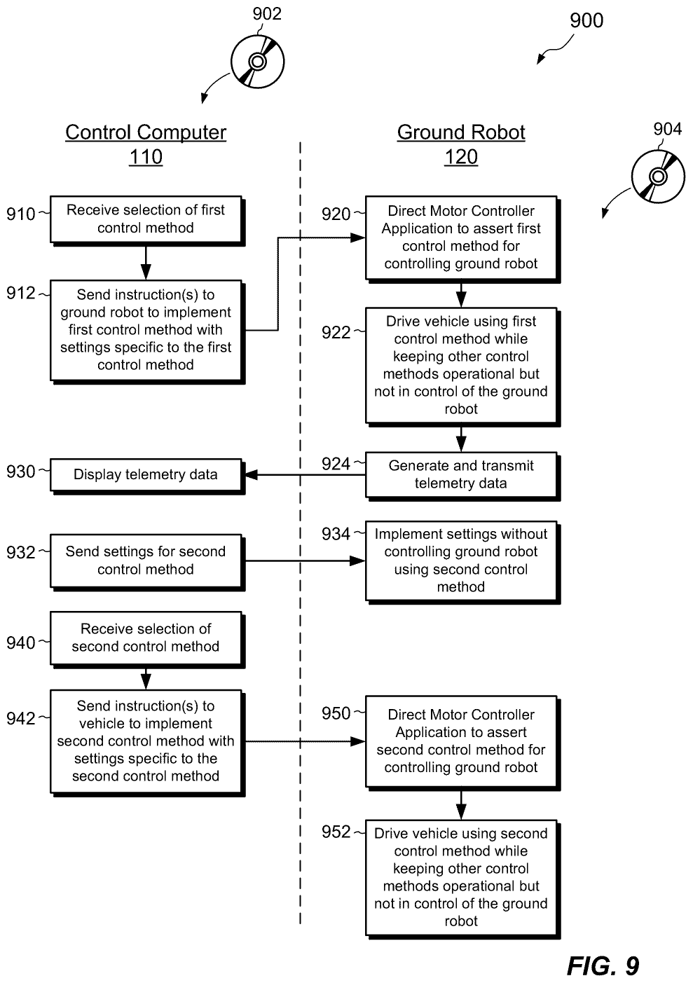

FIG. 9 shows an example method 900 for controlling a ground robot 120 using a control computer 110 and provides an overview of some of the features described above. Activities performed by the computer 110 are shown to the left, and activities performed by the ground robot 120 are shown to the right. One should appreciate that the depicted order of acts is merely illustrative, as embodiments may be constructed in which acts are performed in different orders, which may include performing some acts simultaneously.

At 910, the computer 110 receives, e.g., via the GUI 250, a selection of a first control method, which may be any of the above-described methods (e.g., torque, aided torque, speed, heading, or waypoint). At 912, the computer 110 sends one or more RPI messages 210a to the ground robot 210 to implement the first control method with settings specific to the first control method, such as torque settings, speed settings, heading settings, waypoint settings, or the like.

At 920, the ground robot receives the RPI message(s) and directs the motor controller application 330 to select the first control method as the selected method 332 for controlling the ground robot 120. At 922, the ground robot drives using the first control method while keeping the other control methods (or some subset of them) operational but not in control of the ground robot 120. At 924, as the ground robot operates, the ground robot 120 generates telemetry data and sends the telemetry data back to the computer 100. At 930, the computer 110 displays the telemetry data on the GUI 250. One should appreciate that acts 924 and 930 may be performed continuously.

At 932, the computer 110 sends one or more settings to the ground robot 120 defining operation of the ground robot under a second control method, which is not yet selected. At 934, the ground robot 120 implements the settings and operates the second control method without using the second control method to control the ground robot 120. Steps 932 and 934 may be optional in certain embodiments.

Sometime later, at 940, the computer 110 receives a user selection of a second control method, which is different from the first control method. At 942, the computer 110 sends one or more RPI messages 210a to the ground robot 120 to implement the second control method. The messages 210a may include settings specific to the second control method (e.g., if the settings were not sent previously).

At 950, the ground robot receives the RPI message(s) and directs the motor controller application 330 to select the second control method as the selected method 332 for controlling the ground robot 120. At 952, the ground robot drives using the second control method while keeping the other control methods (or some subset of them) operational but not in control of the ground robot 120.

### Section II: Robotic Platform Interface:

Section II presents additional example features of the robotic platform interface (RPI) according to one or more embodiments. Such features relate generally to associating a control computer 110 with the ground robot 120, enforcing exclusivity in control of the ground robot 120 by a single control computer 110, and monitoring telemetry data of the ground robot 120 by one or more control computers 110.

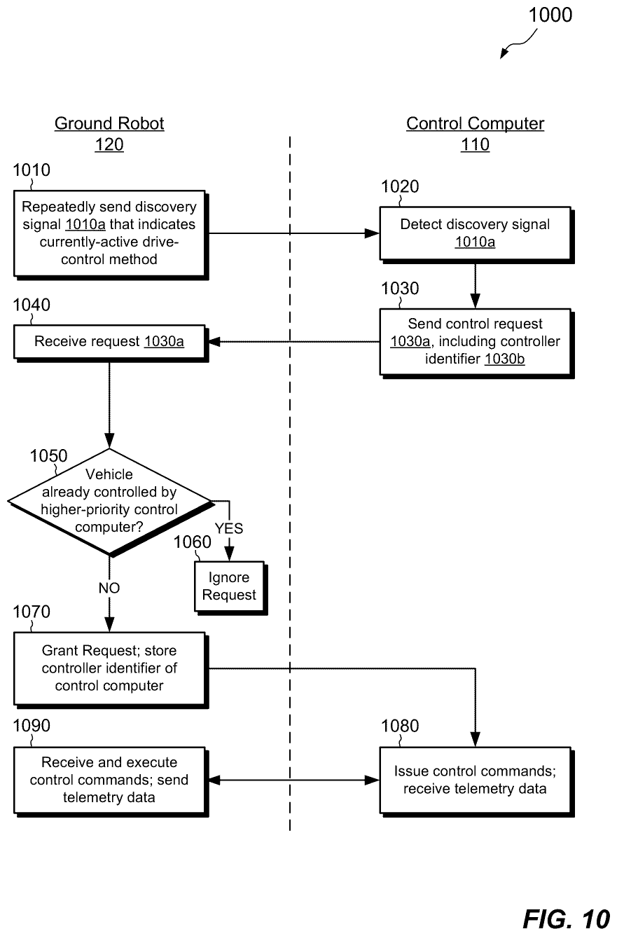

FIG. 10 shows an example method 1000 of associating a ground robot 120 with a control computer 110, according to one or more embodiments. Such association enables the control computer 110 to control the ground robot 120 in an environment in which multiple control computers are present and are capable of controlling the ground robot.

At 1010, the method 1000 begins with the ground robot 120 repeatedly emitting a discovery signal 1010a via a wireless interface 310 (FIG. 3), e.g., via UDP over IP or local CAN bus. In an example, the discovery signal 1010a encodes a mobility message that indicates a drive-control method which is currently active in the ground robot 120, such as differential torque control or speed-and-steering control, for example. The discovery signal 1010a may also include an address of the ground robot. In some examples, the ground robot 120 sends the discovery signal 1010a at regular intervals, i.e., periodically.

At 1020, the control computer 110 detects the discovery signal 1010a, e.g., by listening over the antenna 112 to a broadcast address over a UDP port or to a local CAN bus interface. At 1030, the control computer 110 sends a control request 1030a to the ground robot, e.g., at the address included in the discovery signal 1010a. In an example, the control request 1030a includes a controller identifier 1030b that uniquely identifies the control computer 110. The control request 1030a need not take any special form and in some examples may simply be a control command, i.e., a command for operating the ground robot.

At 1040, the ground robot 120 receives the control request 1030a and, at 1050, determines whether the ground robot is already controlled by a higher-priority control computer. In an example, priority of control computers is based on controller identifiers 1030b, and a lower value of controller identifier indicates a higher priority. In an example, the ground robot 120 stores the controller identifier 301 of the control computer that currently controls it (FIG. 3) and compares this value with the controller identifier 1030b received at 1040 in the control request 1030a. If the controller identifier 1030b is greater than or equal to the controller identifier 301 stored in the ground robot, then the control request 1030a is ignored (step 1060). Otherwise, operation proceeds to 1070, whereupon the control request 1030a is granted. The ground robot 120 stores the controller identifier 1030b received at 1040 as the new value 301, reflecting the fact that the control computer 110 is now controlling the ground robot. Note that the controller identifier 301 may be set to a reserved value, such as a maximum possible value, to reflect a condition in which no control computer currently controls the ground robot.

At 1080 and 1090, communications between the control computer 110 and the ground robot 120 ensue, with the control computer 110 issuing control commands and receiving telemetry data from the ground robot, and the ground robot receiving the control commands, executing them, and sending telemetry data. The telemetry data may include, for example, fault information, battery status, and engine status of the ground robot, such as the data shown in the status region 430 of the GUI 250 (FIG. 4).

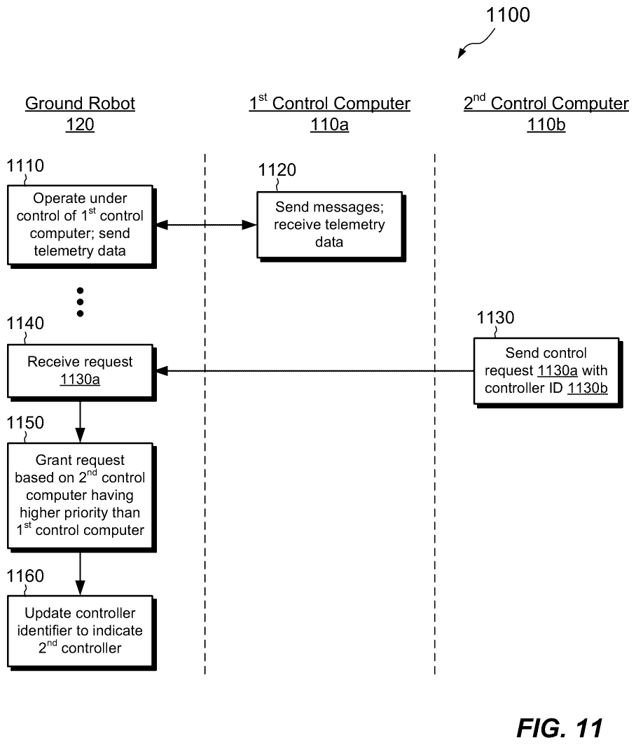

The method 1000 ensures that only one control computer 110 can control the ground robot 120 at a time, but it also allows different control computers to control the ground robot at different times. Although not covered directly in FIG. 11, the illustrated arrangement also allows the same control computer to control multiple ground robots.

FIG. 11 shows an example method 1100 in which a second control computer 110b takes control of a ground robot 120 that is currently being controlled by a first control computer 110a.

At 1110 and 1120, the ground robot 120 engages is communications with the first control computer 110a. For example, the ground robot 120 operates under control of the first control computer 110a, receiving commands issued by the first control computer 110a and providing telemetry data back to the first control computer 110a.

At some point, the second control computer 110b sends a control request 1130a to the ground robot 120, e.g., in a manner similar to that shown in step 1030 of FIG. 10. For example, the second control computer 110b may receive a discovery signal emitted by the ground robot 120 while the ground robot 120 is being controlled by the first control computer 110a. For this example, it is assumed that the control request 1130a includes a controller identifier 1130b that is smaller than the controller identifier 301 currently stored in the ground robot, which matches the controller identifier of the first control computer 110a.

At 1140, the ground robot receives the control request 1130a and, at 1150, grants the control request 1130a based on the second control computer 110b having higher priority (e.g., lower value of controller identifier) than the first control computer 110a.

At 1150, the ground robot 120 updates its stored controller identifier 301 to reflect the controller identifier 1130b of the second control computer 110b. The ground robot 120 proceeds to respond to control from the second control computer 110b in place of the first control computer 110a.

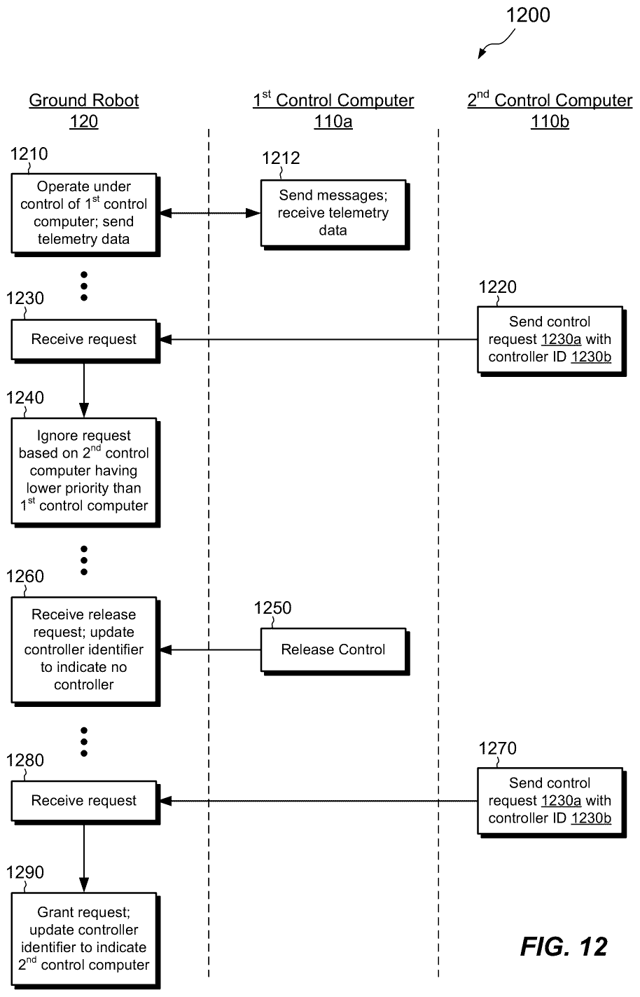

FIG. 12 shows an example method 1200 in which a control request from a second control computer 110b is initially refused but is later granted based on a first control computer 110a actively releasing control over the ground robot 120. At 1210 and 1212, the ground robot 120 engages in communications with the first control computer 110a. For example, the ground robot 120 operates under control of the first control computer 110a, receiving commands issued by the first control computer 110a and providing telemetry data back to the first control computer 110a.

At some point shown at 1220, the second control computer 110b sends a control request 1230a to the ground robot 120, e.g., in a manner similar to that show in step 1130 of FIG. 11. For example, the second control computer 110b receives a discovery signal emitted by the ground robot 120 while the ground robot 120 is being controlled by the first control computer 110a. For this example, it is assumed that the control request 1130a includes a controller identifier 1230b that is greater than the controller identifier 301 currently stored in the ground robot, which matches the controller identifier of the first control computer 110a.

At 1230, the ground robot receives the control request 1230a and, at 1140, ignores (refuses) the control request 1230a, based on the second control computer 110b having lower priority (e.g., greater value of controller identifier) than the first control computer 110a.

Sometime later at 1250, however, the first control computer 110a sends a release request to the ground robot 120. At 1260, the ground robot 120 receives the release request and proceeds to update the controller identifier 301 to indicate that there is no active controller, e.g., by setting the controller identifier 301 to its maximum value or to some other reserved value.

At 1270, which may occur sometime later, the second control computer 110b again sends a control request to the ground robot 120. The ground robot receives the control request at 1280 and grants the request at 1290, updating the controller identifier 301 to contain the controller identifier 1230b of the second control computer 110b. The ground robot 120 proceeds to respond to control from the second control computer 110b in place of the first control computer 110a.

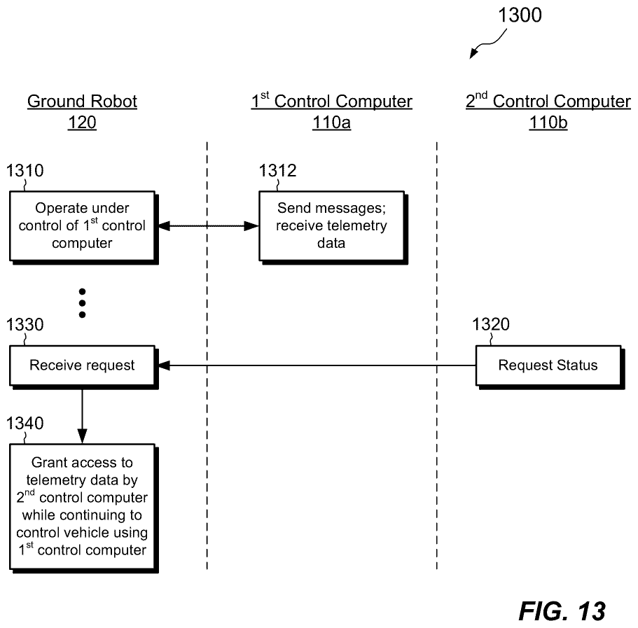

FIG. 13 shows an example method 1300 of controlling the ground robot 120 using a first control computer 110a while simultaneously providing telemetry data to a second control computer 110b. Method 1300 may be used, for example, to monitor faults, battery status, engine status, etc., without the burden of control. The functionality provided by method 1300 has applications in debugging and engineering, as well as in fleet management.

At 1310 and 1312, the ground robot 120 operates under control of a first control computer 110a, receiving commands issued by the first control computer 110a and providing telemetry data back to the first control computer 110a.

Sometime later at 1320, a second control computer 110b sends a status request to the ground robot 120. The ground robot 120 receives the status request at 1330. At 1340, the ground robot 120 grants the second control computer 110b access to telemetry data, while the first control computer 110a continues to control the ground robot.

One should appreciate that any number of control computers may request and receive telemetry data from the ground robot while a single control computer actively controls the ground robot, or even if no control computer actively controls the ground robot. Priority is not a concern when providing telemetry data, as any compatible control computer may obtain it. Security measures may be provided to restrict access, but those are outside the scope of the instant disclosure.

In some examples, the telemetry data sent by the ground robot 120 includes one or more diagnostic trouble codes along with accompanying human-readable text descriptions of the diagnostic trouble codes. The text descriptions enable a human user to easily understand the nature of the trouble codes and avoid having to provide translations between trouble codes and human-readable text as part of the software running on the control computers. Text descriptions can be easily updated just by updating the software running in the ground robot 120.

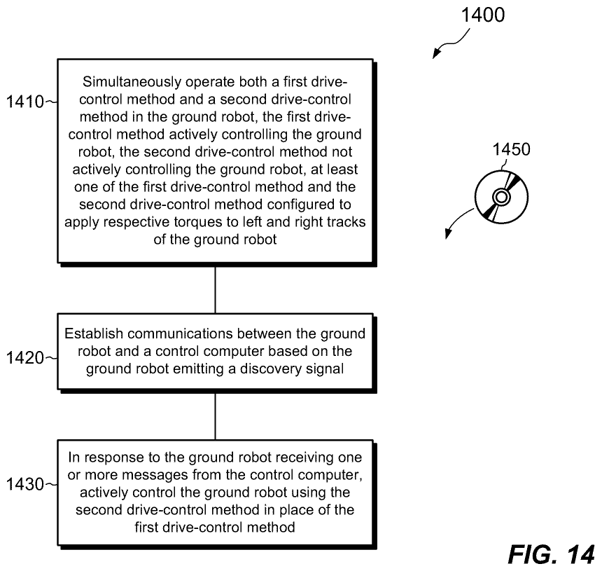

FIG. 14 shows an example method 1400 that may be carried out in connection with the environment 100 and provides an overview of some of the features described above. The method 1400 is typically performed, for example, by the software constructs described in connection with FIG. 3, which reside in the memory 314 of the electronic system 300 of the ground robot 120. One should appreciate that the depicted order of acts is merely illustrative, as embodiments may be constructed in which acts are performed in different orders, which may include performing some acts simultaneously.

At 1410, the ground robot 120 simultaneously operates both a first drive-control method and a second drive-control method. The first drive-control method actively controls the ground robot 120, and the second drive-control method does not actively control the ground robot 120. For example, the ground robot 120 keeps the second drive-control method operational but not in control of the ground robot 120.

At least one of the first drive-control method and the second drive-control method is configured to apply respective torques to left and right tracks 140a and 140b of the ground robot. For example, the first drive-control method and the second drive-control method may be any of differential torque control, aided differential torque control, speed-and-steering control, heading control, and waypoints control, as described in Section I and particularly in connection with FIGS. 4-7. As shown in the example of FIG. 3, differential torque control, aided differential torque control, speed-and-steering control, heading control, and waypoints control all resolve to differential torque controls applied to the left and right tracks 140a and 140b by respective motors.

At 1420, communications are established between the ground robot 120 and a control computer 110 based on the ground robot 110 emitting a discovery signal 1010a (FIG. 10). The discovery signal 1010a indicates the currently-active drive-control method, i.e., the first drive-control method. In some examples, the control computer 110 is located remotely from the ground robot 120, in the sense that the control computer 110 need not have a physical connection to the ground robot 120, may communicate with the ground robot wirelessly, and may be located any arbitrary distance away from the ground robot.

At 1430, the ground robot 120 receives one or more messages from the control computer 110. In response to the message or messages, the ground robot 120 transitions to being actively controlled using the second drive-control method in place of the first drive-control method. For example, the message or messages include commands for a different drive-control method than the one indicated by the discovery signal 1100a. Such commands may be entered, for example, by a user selecting the second drive-control method from the drop-down list 410 in the GUI 250 and entering desired parameters (FIGS. 4-7). The ground robot 120 proceeds to operate in accordance with the second drive-control method.

In some examples, the method 1400 may be embodied as a computer program product including one or more non-transient, computer-readable storage media 1450, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like. Any number of computer-readable media may be used. The media may be encoded with instructions which, when executed on one or more computers or other processors, perform the process or processes described herein. Such media may be considered articles of manufacture or machines, and may be transportable from one machine to another.

An improved technique has been described that provides an interface between control computers and ground robots. The interface supports multiple drive-control methods and allows for steering of the ground robot using differential track control. Advantageously, the improved technique leverages the capabilities of ground robots and is better suited for their control.

Having described certain embodiments, numerous alternative embodiments or variations can be made. Also, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of controlling a ground robot, comprising:
simultaneously operating both a first drive-control method and a second drive-control method in the ground robot, the first drive-control method actively controlling the ground robot, the second drive-control method not actively controlling the ground robot, at least one of the first drive-control method and the second drive-control method configured to apply respective torques to left and right tracks of the ground robot;
establishing communications between the ground robot and a control computer based on the ground robot emitting a discovery signal; and
in response to the ground robot receiving one or more messages from the control computer, actively controlling the ground robot using the second drive-control method in place of the first drive-control method.

2. The method of claim 1, wherein the first drive-control method is one of a differential torque drive-control method and a speed and steering drive-control method, and wherein the second drive-control method is one of a heading drive-control method and a waypoints drive-control method.

3. The method of claim 1, wherein establishing communications between the ground robot and the control computer is performed using one of (i) CAN (controller area network) and (ii) UDP (user datagram protocol) over IP (Internet protocol).

4. The method of claim 1, wherein emitting the discovery signal includes wirelessly sending a mobility message periodically, the mobility message indicating a currently active drive-control method in the ground robot.

5. The method of claim 4, further comprising updating a controller identifier of the ground robot to identify the control computer from among multiple control computers as a sole active controller of the ground robot.

6. The method of claim 1, further comprising, while the control computer is actively controlling the ground robot, transmitting telemetry data about the ground robot to a second control computer to enable the second control computer to display the telemetry data of the ground robot.

7. The method of claim 6, wherein the telemetry data includes at least one of fault information, battery status, and engine status of the ground robot.

8. The method of claim 6, wherein transmitting the telemetry data includes sending a diagnostic trouble code along with an accompanying human-readable text description of the diagnostic trouble code.

9. The method of claim 1, further comprising, while the control computer is actively controlling the ground robot:
receiving a request from a second control computer for actively controlling the ground robot; and
granting control of the ground robot to the second control computer responsive to the second control computer having higher priority than the control computer.

10. The method of claim 1, further comprising, while the control computer is actively controlling the ground robot:
receiving a request from a second control computer for actively controlling the ground robot; and
refusing the request from the second control computer responsive to the second control computer having lower priority than the control computer.

11. The method of claim 10, further comprising:
receiving a release-control request from the control computer for releasing active control over the ground robot;
after receiving the release-control request, receiving a second request from the second control computer for actively controlling the ground robot; and
granting the second request such that the second control computer actively controls the ground robot.

12. A ground robot, comprising left and right tracks, a wireless interface, and control circuitry constructed and arranged to:
simultaneously operate both a first drive-control method and a second drive-control method in the ground robot, such that the first drive-control method actively controls the ground robot and the second drive-control method does not actively control the ground robot, at least one of the first drive-control method and the second drive-control method configured to apply respective torques to the left and right tracks of the ground robot;
establish communications between the ground robot and a control computer based on the ground robot emitting a discovery signal via the wireless interface; and
in response to receipt by the ground robot of one or more messages from the control computer via the wireless interface, actively control the ground robot using the second drive-control method in place of the first drive-control method.

13. The ground robot of claim 12, further comprising:
a first electric motor arranged to drive the left track; and
a second electric motor arranged to drive the right track,
wherein the control circuitry is further constructed and arranged to control the first electric motor and the second electric motor to apply respective first and second torques to the left and right tracks when each of the first drive-control method and the second drive-control method is active.

14. The ground robot of claim 12, wherein the control circuitry constructed and arranged to emit the discovery signal is further constructed and arranged to wirelessly send a mobility message periodically, the mobility message indicating a currently active drive-control method in the ground robot.

15. The ground robot of claim 14, wherein the control circuitry is further constructed and arranged to update a controller identifier of the ground robot to identify the control computer from among multiple control computers as a sole active controller of the ground robot.

16. The ground robot of claim 12 wherein, while the control computer is actively controlling the ground robot, the control circuitry is further constructed and arranged to transmit telemetry data about the ground robot to a second control computer to enable the second control computer to display the telemetry data of the ground robot.

17. The ground robot of claim 16, wherein the telemetry data includes at least one of fault information, battery status, and engine status of the ground robot.

18. The ground robot of claim 16, wherein transmitting the telemetry data includes sending a diagnostic trouble code along with an accompanying human-readable text description of the diagnostic trouble code.

19. The ground robot of claim 12 wherein, while the control computer is actively controlling the ground robot, the control circuitry is further constructed and arranged to:
receive a request from a second control computer for actively controlling the ground robot; and
grant control of the ground robot to the second control computer responsive to the second control computer having higher priority than the control computer.

20. The ground robot of claim 12 wherein, while the control computer is actively controlling the ground robot, the control circuitry is further constructed and arranged to:
receive a request from a second control computer for actively controlling the ground robot; and
refuse the request from the second control computer responsive to the second control computer having lower priority than the control computer.
